(19) United States
(12) Patent Application Publication
(10) Pub. No.: US 2002/0193278 A1
(43) Pub. Date: Dec. 19, 2002

(54) Composition for cleaning a surface

(76) Inventors: Laura Cermenati, Torino (IT); Maria Papadaki, Chania (GR); Vincenzo Tomarchio, Alcamo TP (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/105,784

(22) Filed: Mar. 25, 2002

(30) Foreign Application Priority Data
Mar. 26, 2001 (EP) 01870063.3

(51) Int. Cl. C11D 17/00

(52) U.S. Cl. 510/465; 510/447; 510/403

(57) ABSTRACT

The present invention encompasses a solid or thickened composition, suitable for cleaning a surface, comprising a polymer, wherein said composition is capable of increasing the hydrophobicity of said surface, to provide a contact angle between water and said surface of between 30° and 55° for at least 5 rinse-dry cycles.

### CROSS REFERENCE TO RELATED APPLICATIONS

This application claims priority under 35 U.S.C. §119(a) to European Application Serial No. 01870063.3, filed Mar. 26, 2001 (Attorney Docket No. CM2521F).

### TECHNICAL FIELD

The present invention relates to compositions, more particularly to solid or thickened compositions for cleaning a surface comprising a polymer, wherein said compositions are capable of increasing the hydrophobicity of said surfaces. Said compositions are particularly suitable for the cleaning of hard surfaces including toilet bowls and the like.

### BACKGROUND

A great variety of cleaning compositions have been described in the art. Indeed, compositions for cleaning hard surfaces, especially for hard surfaces found in bathrooms, such as sanitary fittings (e.g., toilet bowls), bathroom tiles, etc., are already known in the art.

Examples of compositions known in the art include quid acidic cleaning compositions suitable for cleaning bathroom surfaces comprising a homo or copolymer of vinylpyrrolidone, or a mixture thereof, a polysaccharide polymer, or a mixture thereof, an anionic surfactant, and an acid (EP-A-0 957 156), or liquid, thickened toilet bowl cleaning compositions comprising a sulphonate surfactant and a quaternary ammonium surfactant (EP-A-0 832 964), or acidic toilet bowl cleaning compositions comprising sulphuric acid and a specific chelating agent (EP-A-0 729 901).

The currently known compositions are not fully satisfactory from a consumer viewpoint especially regarding the soil adherence prevention, in particular limescale build-up prevention, properties imparted to the surfaces treated therewith. Indeed, consumers are looking for cleaning compositions that would render a surface first treated therewith less prone to soil, such as limescale, mineral encrustation, etc., adherence. Especially, longer lasting soil adherence prevention properties imparted to a surface treated with a cleaning composition may be further improved.

Indeed, surfaces found in bathrooms in general and toilet bowl surfaces in particular are subject to a high number of rinse and dry cycles in-between cleaning operations. For example, in a four-person household, a toilet is flushed approximately 120 times a week, which results in 120 rinse-dry cycles. During each rinse-dry cycle limescale deposition, due to the use of more or less hard water, on the rinsed surface may occur. This leads to a significant limescale and/or mineral encrustation build-up on the surfaces going through these rinse-dry cycles. This also results in a lost of surfaces shine. Furthermore, soils, such as feces, biofilm (bacteria, fungi, algae, and the like), soap scum, etc., may be deposited in-between cleaning operations on said bathroom surfaces.

It is therefore an objective of the present invention to provide a composition for cleaning a surfaces, wherein said composition renders surfaces therewith less prone to soil adherence over a longer period of time.

It has now been found that the above objective can be met by a composition according to the present invention.

An advantage of the present invention is that the compositions according to the present invention also provide a next-time cleaning benefit by facilitating the removal of soil from the surfaces treated therewith.

Advantageously, the compositions as described herein may be used to clean surfaces made of a variety of materials like glazed and non-glazed ceramic tiles, enamel, stainless steel, Inox®, Formica®, vinyl, no-wax vinyl, linoleum, melamine, glass, plastics and plastified wood.

A further advantage of the present invention is that the compositions according to the present invention have the ability to provide shine to the surface they have cleaned.

### BACKGROUND ART

The following documents are representative of the prior art available on surface modifying compositions.

EP-A-0 957 156 discloses acidic cleaning compositions suitable for cleaning bathroom surfaces comprising a homo or copolymer of vinylpyrrolidone, or a mixture thereof, a polysaccharide polymer, or a mixture thereof, an anionic surfactant, and an acid.

WO 97/36967 discloses a method for imparting hydrophobicity to the surface of a substrate comprising the steps of applying to said surface a solution having less than 2 ppm of an organofunctional silane and repeating the application until said surface exhibits an in crease in hydrophobicity.

The Applicant's Copending Application PCT/US 99/25912 (Attorney's docket number CM 2147M) discloses cleaning compositions suitable for cleaning a surface comprising a surface substantive polymer wherein said polymer is capable of modifying the surface to render it hydrophilic, providing a contact angle between water and the surface of less than 50°.

### SUMMARY OF THE INVENTION

The present invention encompasses a solid or thickened compositions, suitable for cleaning a surface, comprising a polymer, wherein said composition is capable of increasing the hydrophobicity of said surface, to provide a contact angle between water and said surface of between 30° and 55° for at least 5 rinse-dry cycles.

In a preferred embodiment said polymer is an anti soil-adherence polymer, preferably a silicone glycole.

The present invention also encompasses a process of increasing the hydrophobicity of a surface, to provide a contact angle between water and said surface of between 30° and 55° for at least 5 rinse-dry cycles comprising the step of applying a solid or thickened compositions, suitable for cleaning said surface, comprising a polymer.

### DETAILED DESCRIPTION OF THE INVENTION

Surface Properties

The compositions according to the present invention are suitable to modify the surface properties of a surface cleaned therewith. The surfaces before being cleaned with the composition herein are initially more or less hydrophilic or hydrophobic. The hydrophilic/hydrophobic surfaces properties of a given surface, this means before and/or after the application (cleaning) of a composition, can be assessed by measuring the contact angle of a solvent and said surface. The general principles of hydrophilic/hydrophobic interaction between surfaces and the relation between contact angles and hydrophilic/hydrophobic surface properties can be found in “Interfacial phenomena Equilibrium and dynamic effects” by C. Miller and P. Neogi, pages 54-90, M. Deker Inc. 1987.

As outlined above, the hydrophilic/hydrophobic properties of a given surface are assessed by measuring the contact angle between a solvent and said surface. In the present invention, the solvent used to assess the hydrophilic/hydrophobic properties of a given surface is deionized water. Contact angle measurements are done using, for example, a Dataphysics® Optical contact Angle (“OCA”) instrument (OCA 20®). The OCA measures the contact angle θ of the solvent, such as water, on a surface. In the case where water is used as solvent, the higher said contact angle is, the more hydrophobic the surface is.

All contact angle measurements as outlined herein below are preformed using the following test methods:

The static contact angles of standard black glossy (SENIO®) or white porcelain tiles (VALM®) with respect to water are measured by the sessile drop method using the Dataphysics Optical Contact Angle (OCA) instrument wherein the tile is placed in a horizontal position, facing upward, in front of a light source. A motor-driven dosing unit delivers 10 μl of water at a given time on the tested surface. An image of the shape of the drop on the surface is taken with a CCD (digital) camera. Then from this image the static contact angle is calculated according to the sessile drop method using the SCA (software for contact angle measurements) software.

The resulting contact angle provided to a tile by a given composition is measured by applying said composition onto said tiles and initially rinsing off the composition from the surface of the tile after a 15 min contact time using 12 lt. of tab water. After the tile has been dried and, rinsed (using 12 lt. of tab water) and dried for a specific number of times (e.g., at least 5 times in case where at least 5 rinse-dry cycles are required), the tile is placed in a horizontal position, facing upward, in front of a light source. A motor-driven dosing unit delivers 10 μl of water at a given time on the tested surface. An image of the shape of the drop on the surface is taken with a CCD (digital) camera. Then from this image the contact angle is calculated according to the sessile drop method using the SCA software.

The compositions according to the present invention are suitable to clean a surface. Any type of surface prone to soiling may be cleaned with the compositions herein. Preferably, the surfaces herein are hard-surfaces, more preferably hard-surfaces typically found in houses like kitchens, bathrooms, or in car interiors or exteriors, e.g., floors, walls, tiles, windows, cupboards, sinks, showers, shower plastified curtains, wash basins, toilet bowls, urinals, fixtures and fittings and the like made of different materials like ceramic, enamel, vinyl, no-wax vinyl, linoleum, melamine, glass, Inox®, Formica®, any plastics, plastified wood, metal or any painted or varnished or sealed surface and the like. Hard-surfaces also include household appliances including, but not limited to refrigerators, freezers, washing machines, automatic dryers, ovens, microwave ovens, dishwashers and so on. In addition, the surface herein may be the surface of a denture, this means the composition herein may also be used as a denture cleaner.

In a highly preferred embodiment the surfaces herein are hard-surfaces found in bathrooms, such as tiles, sinks, showers, wash basins, toilet bowls, urinals, bath-tubs, fixtures and fittings and the like made of different materials like ceramics, enamel, glass, Inox®, Formica®, or metal, and the like. Even more preferably, the surface herein are toilet bowls and urinals, most preferably the inside portion of a toilet bowls and urinals. In a highly preferred embodiment the surfaces herein are porcelain, ceramic and glass tiles.

The surfaces herein initially, this means prior to the application of the composition herein, preferably are “substantially hydrophilic surfaces”. By “substantially hydrophilic surfaces” it is meant herein that the surfaces have a contact angle of below 55°, preferably from O to 40°, more preferably from 10° to 30°.

Suitable, ceramic surfaces (such as can be found inside toilet bowl or urinals) to be cleaned herein have a contact angle of from 10° to 30°. Typical contact angles of water for bathroom surfaces are: 27° for porcelain surfaces and 14° for black glossy ceramic tiles.

Surface Properties Modification

The compositions herein increase the hydrophobicity of a surface cleaned with said composition, to provide a contact angle between water and said surface of between 30° and 55° for at least 5 rinse-dry cycles.

In a preferred embodiment, the contact angle between water and said surface is of from 30° to 50°, more preferably of from 30° to 47°, and most preferably of from 35° to 47°. Preferably, the surface is increased to medium hydrophobic by the application of the compositions thereon. By “medium hydrophobic” it is meant herein an increase of the initial hydrophilicity/hydrophobicity to a level resulting in a contact angle between water and said surface as outlined herein above.

In another preferred embodiment the difference in contact angle between water and said surface prior to the application of the compositions according to the present invention (i.e., cleaning) and after said application (Δ contact angle) is from 5° to 36°, preferably from 10° to 30°, more preferably from 10° to 20° and most preferably from 15° to 18°.

In still another preferred embodiment, said contact angle between water and said surface (after the in initial treatment with the product) remains for at least 5 rinse-dry cycles, preferably at least 15 rinse-dry cycles, more preferably at least 40 rinse-dry cycles, still more preferably at least 60 rinse-dry cycles, even more preferably at least 80 rinse-dry cycles, still even more preferably at least 100 rinse-dry cycles and most preferably at least 120 rinse-dry cycles. Preferably, the surface modification is effective over a prolonged period of time. By “a prolonged period of time” it is meant herein over the time necessary for the rinse-dry cycles as outlined herein above to take place.

By “rinse-dry cycles” it is meant herein, the rinsing of the surface herein with a liquid, preferably water, more preferably tap water, and the drying of said surface after the rinsing step. During the rinse-dry cycles the surfaces herein substantially dries, this means that said liquid is substantially completely removed from the surface, by e.g., running off said surface (e.g., for inclined surfaces) or evaporating (e.g., for inclined or horizontal surfaces) from said surface. However, it may occur under given circumstances that a further rinsing step is performed prior to the complete drying of the surface. This does not alter the performance of the present invention. In the above described test method, the tiles are rinsed using 12 lt. of tab water.

Typical rinse-dry cycles as described herein are for example the flushing of a toilet or a urinal or the rinsing of bathroom tiles, sinks, shower cabins, bath tubs and the like.

The contact angle of a given surface after cleaning with a given composition and a given amount of rinse-dry cycles can be assessed using the following test method:

The static contact angles of black glossy tiles with respect to water, treated or not treated with the product and exposed to up to 120 rinse-dry cycles, are measured by the sessile drop method using the Dataphysics Optical Contact Angle (OCA) instrument. The dried surface is placed in a horizontal position, facing upward, in front of a light source. A motor-driven dosing unit delivers 10 μl of water at a given time on the tested surface. An image of the shape of the drop on the surface is taken with a high resolution CCD (digital) camera. Then from this image the static contact angle is calculated according to the sessile drop method using the SCA software.

It has now been found that by increasing the hydrophobicity of a surface, providing a contact angle between water and said surface of between 30° and 55° and maintaining said contact angle over a prolonged period of time, meaning for at least 5 rinse-dry cycles, said surface is rendered less prone to soil adherence over a prolonged period of time (“soil adherence prevention benefit”). In particular, the adherence and/or the build-up of limescale and mineral encrustation, etc., is significantly reduced or even prevented over a prolonged period of time (“limescale build-up prevention benefit”; “mineral encrustation build-up prevention benefit”). Indeed, surfaces and preferably surfaces found in bathrooms in general and toilet bowl surfaces in particular are subject to a high number of rinse and dry cycles in-between cleaning operations. For example, in a four-person household, a toilet is flushed approximately 120 times a week, which results in 120 rinse-dry cycles, or a bath-tub or the tiles found in a shower are subject to rinsing after each use of the bath-tub/shower, in a four-person household this may result in up to 30 rinse-dry cycles. During each rinse-dry cycle limescale and/or mineral encrustation deposition, due to the use of more or less hard water, on the rinsed surface may occur. This leads to a significant limescale and/or mineral encrustation build-up on the surfaces going through these rinse-dry cycles. Furthermore, soils, such as feces, biofilm (bacteria, fungi, algae, and the like), soap scum, etc., may be deposited in-between cleaning operations on said bathroom surfaces.

Although not wishing to be bound by theory, the Applicant has surprisingly found that the compositions comprising a polymer, as described herein, are able to keep a contact angle between water and said surface of between 30° and 55° and maintaining said contact angle over a prolonged period of time on a surface cleaned with said compositions. The reduction of soil adherence, preferably limescale and/or mineral encrustation adherence, on a surface having a contact angle between water and said surface of between 30° and 55° (increased hydrophobicity) is due to the fact that limescale or waterborne soils do not stick to the surface because with the medium degree of hydrophobic modification (contact angle of from 30 to 55 degrees) achieved by the present invention water droplets, containing limescale or water borne soils, do not strongly adhere to the surface and fall with a retracting tail for complete water drainage. With a higher degree of hydrophobisation drenched surfaces leave droplets behind and look less shiny after a few rinse and dry cycles.

The above described effect is preferably due to the deposition of the polymer onto said surface.

Furthermore, due to the high numbers of rinsing steps occurring on the surfaces to be cleaned with the compositions according to the present invention, it has been found that the sole initial modification of the surface properties, meaning the rendering of the surface more hydrophobic, after the cleaning step is not sufficient. Indeed, it is an essential element of the present invention that the surface modification is maintained over a prolonged period of time. Thereby the prevention of soil adherence, preferably limescale and/or mineral encrustation adherence, is prevented in-between two cleaning operations. Indeed, such cleaning operations are usually not performed after each rinse-dry cycle as described herein but after several rinse-dry cycles (such as once every couple of days or once a week). However, in case of constant application of a composition, for example by placing a rim block into a toilet bowl and/or toilet water tank, a constant exposure of the surface herein is also possible.

The soil adherence prevention benefit in general and the limescale and/or mineral encrustation build-up prevention benefit in particular of a given composition over a given amount of rinse-dry cycles can be assessed using the following test method:

Ceramics tiles (20×20 cm) are uniformly covered with 5 ml of the product. After 15 minutes the tiles are rinsed (1 minute) with tap water (with 12 lt. of tab-water): a curtain water drainage effect is observed and no water is left on the surface after 5 seconds. The tiles are left in vertical position and the rinsing with tap water (15 seconds) is repeated every 30 minutes. Results are evaluated vs. either untreated tiles subjected to the same number of rinse/dry cycles or vs. virgin tiles. The tested surfaces can be white or colored, preferably colored. The limescale and/or mineral encrustation build-up prevention benefit of said composition can be assessed by visual grading. The visual grading may be performed by a group of expert panelists using panel score units (PSU). To asses the limescale and/or mineral encrustation build-up prevention benefit of a given composition a PSU-scale ranging from 0, meaning no noticeable difference in limescale and/or mineral encrustation build-up of a treated tile versus an un-treated tile, to 6, meaning a clearly noticeable difference in limescale and/or mineral encrustation build-up of a treated tile versus an un-treated tile, can be applied.

Composition

The composition of the present invention is either formulated as a thickened or solid composition.

In the preferred embodiment, wherein the compositions herein are solid compositions, the composition may for example come in the form of a powder, as granules, as pressed granules and/or powders (such as tablets), extruded solid compositions and the like. Preferably, the solid compositions herein are in the form of a tablet, such as a rim block or in-cistern devices for toilet or urinals, preferably to be placed directly into toilet bowl or urinal or into the fresh water tank of a WC or a urinal, or mechanicals cleaning devices for the bathroom.

In the preferred embodiment, wherein the compositions herein are thickened compositions, the compositions herein may be in the form of a gel or a pasteous composition. Preferably, the thickened compositions herein are liquid, thickened compositions. Preferred thickened compositions of the present invention have a viscosity of 2 cps or greater, more preferably of from 2 to 5000 cps, and still more preferably of from 10 to 2500 cps, when measured with a Carri-Med Rheometer model CSL² 100® (Supplied by TA Instruments) at 20° C. with a 4 cm conic spindle in stainless steal (linear increment from 1 to 70 sec⁻¹ in max. 8 minutes).

Most preferred thickened compositions have a specific shear thinning profile. Most preferably the viscosity should be in the range of 100-500 cps at 10 sec⁻¹, 50-400 cps at 30 sec⁻¹ and 10-50 cps at 700 sec⁻¹.

It is at these preferred viscosities where the thickened compositions herein show a good distribution of the composition over the surface to be cleaned as well as an adherence to said surface sufficient to stick to the surface during the cleaning operation itself. Furthermore, the rinsing-off of said composition of the surface after the cleaning is also beneficial.

The thickened compositions herein are, when applied to the surface to be cleaned sufficiently hydrophilic to ensure a good distribution over said surface (even when this surface is covered with water) and an easy rinsability. The hydrophilic properties of the composition itself herein are not to be confused with the effect of providing an increased hydrophobicity to the surface to be cleaned.

The hydrophilicity of the compositions herein itself may be assessed whilst adhering to the surface to be cleaned, meaning prior to the rinsing-off of said composition, using the following test method:

It is submitted that the contact angle measurements of the composition applied onto the surface to be cleaned has to be performed using a solvent that does not mix with the thickened composition, in order to avoid the rinsing-off of said composition from said surface. Therefore, for water-based compositions an apolar solvent such as diiodomethane is used.

The static contact angles of the product on the surface with respect to diiodomethane, are measured by the sessile drop method using the Dataphysics Optical Contact Angle (OCA) instrument. Product is applied on a white porcelain tile and after 15 min contact time, the surface to be measured is placed in a horizontal position, facing upward, in front of a light source. A motor-driven dosing unit delivers 10 μl of diiodomethane at a given time on the tested surface. An image of the shape of the drop on the surface is taken with a high resolution CCD (digital) camera. Then from this image the static contact angle is calculated according to the sessile drop method using the SCA software.

In a preferred embodiment according to the present invention the thickened, aqueous compositions herein have a contact angle between di-iodomethane and said surface covered with said composition of from 20° to 45°, preferably of from 20° to 40°, more preferably of from 20° to 30°, and most preferably of from 25° to 30°.

A preferred thickened composition herein is an aqueous composition and therefore, preferably comprises water more preferably in an amount of from 20% to 99%, even more preferably of from 75% to 97% and most preferably 80% to 97% by weight of the total composition.

The pH of the thickened composition according to the present invention may typically be from 0 to 14. Preferably, the pH of the thickened compositions herein, as is measured at 25° C., is at least, with increasing preference in the order given, 0.1, 0.15, 0.2, 0.25, 0.3, or 0.4. Independently, the pH of the thickened compositions herein, as is measured at 25° C., preferably is no more than, with increasing preference in the order given, 14, 13, 12, 11, 10, 9, 8, 7, 6, 6, 5, 4.5, 4, 3.5, 3, 2.5, 2, 1.75, 1.5, 1.25, 1, 0.75, 0.5, 0.45 or 0.4.

The pH of the solid composition according to the present invention at a dilution with water of 1%, may typically be from 0 to 14. Preferably, the pH of the solid compositions herein, as is measured at 25° C., is at least, with increasing preference in the order given, 0, 1, 2, 3, 4, 5, 6, 7. Independently, the pH of the solid compositions herein, as is measured at 25° C., preferably is no more than, with increasing preference in the order given, 14, 13, 12, 11, 10, 9 or 8.

Accordingly, the compositions herein may further comprise an acid or base to adjust pH as appropriate. Preferably, the compositions herein may further comprise an acid.

Acidity further contributes to formulate compositions according to the present invention that exhibit good limescale removing performance whilst exhibiting also good disinfecting properties. Accordingly, the compositions of the present invention may comprise organic and/or inorganic acids. Particularly suitable organic acids to be used herein are aryl and/or alkyl sulfonate, such as methane sulfonic acids, citric acid, succinic acid, sulpharnic acid, maleic acid and the like. Particularly suitable inorganic acids are sulfuric, phosphoric, nitric acids and the like.

A typical level of such an acid, when present, is of from 0.01% to 15%, preferably from 1% to 10% and more preferably from 2% to 7% by weight of the total composition. 30

Polymer

The composition herein comprises a polymer.

In a preferred embodiment according to the present invention, said polymer provides the increased hydrophobicity for a prolonged period of times as described herein above to the cleaned surface. Preferably, said polymer is a soil adhesion prevention polymer, more preferably, said polymer is a limescale and/or mineral encrustation build-up prevention polymer, and most preferably said polymer is a limescale build-up prevention polymer.

Preferably, any polymer, providing the increased hydrophobicity to the cleaned surface for a prolonged period of times as described herein above, preferably having the limescale and/or mineral encrustation build-up prevention properties for a prolonged period of times as described herein above, can be used in the compositions according to the present invention.

The composition herein preferably comprises up to 50%, more preferably of from 1% to 20%, even more preferably of from 0.01% to 10%, and most preferably of from 0.01% to 5%, by weight of the total composition of said polymer.

Suitable polymers for use herein are silicone glycol polymers. Depending on the relative position of the silicone-polyether chains, the polymer can be: linear or grafted.

Preferably, said polymer is a silicone glycol according to the following formula:

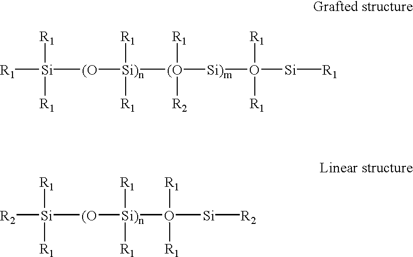

wherein: each R₁ independently is H or a hydrocarbon radical; R₂ is a group bearing a polyether functional group; n is an integer of from 0 to 500; and for the grafted structure m is an integer of from 1 to 300, and preferably with n+m more than 1.

In a highly preferred embodiment herein the polymer herein is a grafted silicone glycol.

Preferably, each R₁ independently is H or a hydrocarbon chain comprising from 1 to 16, more preferably a hydrocarbon chain comprising from 1 to 12 carbon atoms, and even more preferably R₁ is a CH₃-group. R₁ can also contain NH₂ groups and/or quaternary ammoniums.

Preferably, n is an integer of from 0 to 100, more preferably an integer of from 1 to 100, even more preferably n is an integer of from 1 to 50, and most preferably n is an integer of from 5 to 30.

Preferably, m (for the grafted structure) is an integer of from 1 to 80, more preferably m is an integer of from 1 to 30, and even more preferably m is an integer of from 2 to 10. Preferably, n+m is more than 2.

Preferably, R₂ is an alkoxylated hydrocarbon chain. More preferably, R₂ is according to the general formula:

—R₃—(A)ₚ—R₄ or —(A)ₚ—R₄

wherein: R₃ is a hydrocarbon chain; A is an alkoxy group or a mixture thereof; p is an integer of from 1 to 50; and R₄ is H or a hydrocarbon chain, or —COOH.

Preferably, R₃ is a hydrocarbon chain comprising from 1 to 12, more preferably 3 to 10, even more preferably from 3 to 6, and most preferably 3 carbon atoms.

Preferably, A is an ethoxy or propoxy or butoxy unit or a mixture thereof, more preferably A is an ethoxy group.

Preferably, p is an integer of from 1 to 50, more preferably p is an integer of from 1 to 30, and even more preferably p is an integer of from 5 to 20.

Preferably, R₄ is H or a hydrocarbon chain comprising from 1 to 12, more preferably 1 to 6, even more preferably from 3 to 6, and still even preferably 3 carbon atoms, most preferably R₄ is H.

Preferably, the silicone glycol polymers suitable herein have an average molecular weight of from 500 to 100,000, preferably from 600 to 50,000, more preferably from 1000 to 40,000, and most preferably from 2,000 to 20,000.

Suitable, silicone glycol polymers are commercially available from General electric, Dow Corning, and Witco under the following tradenames:

| GE Bayer Silicones: | Dow Corning: | Witco: |
|---|---|---|
| SF1488 ® | DC 8692 ® | L-77 ® |
| SF1288 ® | Q4-3667 ® | L-7001 ® |
| SF1388 ® | DC 5067 ® | L-7087 ® |
| SF1328 ® | DC 1248 ® | L-7200 ® |
| SF1528 ® | DC 3225C ® | L-7210 ® |
| SF1188 ® | DC 5225C ® | L-7220 ® |
| TP3799 ® | DC 190 ® | L-7230 ® |
| TP3800 ® | DC 5247 ® | L-7280 ® |
| TP3801 ® | FF 400 ® | L-7500 ® |
| TP3804 ® | DC 5329 ® | L-7510 ® |
| TP3805 ® | DC 5220 ® | L-7550 ® |
| TP3806 ® | DC 5097 ® | L7600 ® |
| TSF4440 ® | DC 5604 ® | L-7602 ® |
| TSF4441 ® | DC 5197 ® | L-7604 ® |
| TSF4445 ® | DC 5103 ® | L-7605 ® |
| TSF4446 ® | DC 5093 ® | L-7607 ® |
| TSF4452 ® | DC 5237 ® | L-7608 ® |
| TSF4460 ® | DC 5098 ® | L-7622 ® |
| TSF4450 ® | DC 193 ® | L-7644 ® |
| AI3669 ® | DC 5200 ® | L-7650 ® |
| AI3465 ® | Sylgard 309 | L-7657 ® |
| AI3466 ® | DC 5211 ® | L-8500 ® |
| AI3467 ® | DC 5212 ® | L-8600 ® |
| AI3468 ® | | L-8610 ® |
| | | L-8620 ® |

In a highly preferred embodiment according to the present invention, the polymer herein is a Silicones-Polyethers copolymer, commercially available under the trade name SF 1288® from GE Bayer Silicones.

In addition, to the long term soil adherence prevention, preferably limescale build-up prevention, properties provided by the compositions, preferably polymers, described herein, the use of such a composition, preferably polymer, may also provide a short time soil adhesion prevention properties wherein different soils, such as feces, biofilm (bacteria, fungi, algae, and the like), soap scum, etc., are prevented from sticking to the surfaces cleaned with the compositions according to the present invention. In order, to achieve the prevention of adherence of such more other soils to the surfaces over prolonged period of times, the constant application of the composition herein onto the surfaces to be cleaned has to be provided. Such a constant application, can for example be achieved by a rinse rim block to a WC or urinal or by fitting a WC or urinal with a constant delivery system for a thickened composition herein.

Polymers not providing the increased hydrophobicity to the cleaned surface for a prolonged period of times as described herein above, cannot be used in the compositions according to the present invention. Examples, of such polymers when used in compositions to clean surfaces failing to modify said surfaces at all, meaning that there is no increase, not enough or too much increase in hydrophobicity of the surface after the cleaning, are for example: Xanthan gum or other polysaccharides, polyvinyl pyridine N-oxide (PVNO), polyacrylates and/or fluoro-polymers.

Furthermore, there is a class of polymers that may eventually initially increase the hydrophobicity of a surface cleaned with a composition comprising said polymers and thereby providing a contact angle between water and said surface of between 30° and 55° (measured after a first rinsing step). However, this class of polymers is removed from the surface after only a few rinse-dry cycles. Indeed, the increase in hydrophobicity provided by this class of polymers wears off after a relatively short period of time, starting as soon as with the first rinse-dry cycle after the cleaning operation. Polymers in this class of polymers include polyvinyl pyrrolidone (PVP).

Processes and Uses

The present invention also encompasses a process of increasing the hydrophobicity of a surface, to provide a contact angle between water and said surface of between 30° and 55° for at least 5 rinse-dry cycles comprising the step of applying a solid or thickened composition, suitable for cleaning said surface, comprising a polymer.

Furthermore, the present invention encompasses a process of cleaning a surface with a solid or thickened composition comprising a polymer, wherein said composition increases the hydrophobicity of said surface, to provide a contact angle between water and said surface of between 30° and 55° for at least 5 rinse-dry cycles, wherein said process comprises the step of applying said composition onto said surface.

Preferably, said process of cleaning a surface additionally comprises the steps of leaving said composition to act on said surface and subsequently removing said composition from said surface by rinsing it off, such as flushing a toilet.

In said process of cleaning a surface the thickened composition may be used in its neat or diluted form. In said process of cleaning a surface the solid composition may be used in dissolved form.

By “in its diluted form” it is meant herein that said compositions may be diluted with water up to 99% of water. Said dilution may occur either before, after or while said composition is applied to said surface.

By “in dissolved form” it is meant herein that said solid compositions may be dissolved in water. Said dissolution may occur either before, after or while said composition is applied to said surface.

Furthermore, the present invention encompasses the manufacture of a composition for use in one of the processes as described herein above.

Moreover, the present invention encompasses the use of a composition comprising a polymer, to clean a surface wherein said composition is capable of increasing the hydrophobicity of said surface, to provide a contact angle between water and said surface of between 30° and 55° for at least 5 rinse-dry cycles, thereby providing a soil adherence prevention benefit.

In addition, the present invention encompasses the use of a composition comprising a polymer, to clean a surface wherein said composition is capable of increasing the hydrophobicity of said surface, to provide a contact angle between water and said surface of between 30° and 55° for at least 5 rinse-dry cycles, thereby providing a limescale and/or mineral encrustation build-up prevention benefit.

In addition, the present invention encompasses the use of a composition comprising a polymer, to clean a surface wherein said composition is capable of increasing the hydrophobicity of said surface, to provide a contact angle between water and said surface of between 30° and 55° for at least 5 rinse-dry cycles, thereby providing a feces anti-stick and/or bacteria adhesion reduction benefit.

The feces anti-stick and bacteria adhesion reduction benefits are due to the reduction of friction between the treated surface and another material, which can be for example feces, bacteria, etc., provided by the polymer as described herein. By “reduction of friction” between it is meant herein that the difficulty with which the surface of one material will slide over the surface adjoining itself or another material will be reduced. It is believed that the reduction of the apparent friction reduces the adhesion of feces, bacteria and dirt on the surface and can make the cleaning operation easier to perform.

The reduction of friction is measured herein by the dynamic coefficient of friction. The coefficient of friction for a given composition comprising a polymer as described herein, is described as the ratio of the frictional force to the force (usually gravitational) acting perpendicular to the surfaces in contact. The static or starting coefficient of friction is related to the force measured to begin movement of the surfaces relative to each other. The kinetic or sliding coefficient of friction is related to the force measured in sustaining this movement.

The dynamic coefficient of friction can be assessed by the ASTM D 1894 method using a Tensile tester EJA-1000® from Thwing-Albert (Model 1300-36). In this analysis a significant force must be exerted on a sled before it will begin to move. This force is measured in grams (force) using the load cell on a tensile tester. Once the sled has begun to move, the maintenance of this same force, or a lesser one, will keep the sled in uniform motion without increasing the speed. The forces of kinetic or static friction are observed proportional to the force normal to the surface in contact (normal force=weight of the sled). The kinetic coefficient of friction is measured by the ratio of the load measured by the tensile tester in grams (force) to the total weight of the sled in grams (force).

Optional Ingredients in the Compositions Herein

Bleach

The compositions according to the present invention may comprise, as an optional ingredient, a bleach. Preferably, said bleach is selected from the group consisting of sources of active oxygen, hypohalite bleaches and mixtures thereof.

The bleach, preferably the source of active oxygen according to the present invention acts as an oxidising agent, it increases the ability of the compositions to remove colored stains and organic stains in general, to destroy malodorous molecules and to kill germs.

In a preferred embodiment according to the present invention said bleach is a source of active oxygen or a mixture thereof.

Suitable sources of active oxygen for use herein are water-soluble sources of hydrogen peroxide including persulfate, dipersulphate, persulfuric acid, percarbonates, metal peroxides, perborates, persilicate salts, and mixtures thereof, as well as hydrogen peroxide, and mixtures thereof. As used herein a hydrogen peroxide source refers to any compound that produces hydrogen peroxide when said compound is in contact with water In addition, other classes of peroxides can be used as an alternative to hydrogen peroxide and sources thereof or in combination with hydrogen peroxide and sources thereof. Suitable classes include dialkylperoxides, diacylperoxides, preformed percarboxylic acids, organic and inorganic peroxides and/or hydroperoxides.

Suitable organic or inorganic peracids for use herein are selected from the group consisting of: persulphates such as monopersulfate; peroxyacids such as diperoxydodecandioic acid (DPDA) and phthaloyl amino peroxycaproic acid (PAP); magnesium perphthalic acid; perlauric acid; perbenzoic and alkylperbenzoic acids; and mixtures thereof.

Suitable hydroperoxides for use herein are selected from the group consisting of tert-butyl hydroperoxide, cumyl hydroperoxide, 2,4,4-trimethylpentyl-2-hydroperoxide, di-isopropylbenzene-monohydroperoxide, tert-amyl hydroperoxide and 2,5-dimethyl-hexane-2,5-dihydroperoxide and mixtures thereof. Such hydroperoxides have the advantage to be particularly safe to carpets and carpet dyes while delivering excellent bleaching performance.

Persulfate salts, or mixtures thereof, are the preferred sources of active oxygen to be used in the compositions according to the present invention. Preferred persulfate salt to be used herein is the monopersulfate triple salt. One example of monopersulfate salt commercially available is potassium monopersulfate commercialized by Peroxide Chemie GMBH under the trade name Curox®. Other persulfate salts such as dipersulphate salts commercially available from Peroxide Chemie GMBH can be used in the compositions according to the present invention.

The compositions according to the present invention may comprise from 0.1% to 30%, preferably from 0.1% to 20%, more preferably from 1% to 10%, and most preferably from 1% to 7% by weight of the total composition of said bleach.

Perfumes

The compositions according to the present invention may comprise, as an optional ingredient, a perfume ingredient preferably selected from the group consisting of: a cyclic terpene/sesquiterpene perfume, such as eucalyptol, cedrol, pinocarveolus, sesquiterpenic globulul alcohol; linalo; tetrahydrolinalo; verdox (cyclohexadiyl 2 tetryl butyl acetate); 6,3 hexanol; and citronellol and mixtures thereof.

The compositions according to the present invention may comprise from 0.01% to 10%, preferably from 0.01% to 5%, more preferably from 0.01% to 1%, and most preferably from 0.1% to 0.1% by weight of the total composition of said perfume ingredient.

Surfactants

The compositions according to the present invention may comprise, as an optional ingredient, a surfactant, or mixtures thereof.

The presence of said surfactants in the compositions of the present invention also allows to provide good cleaning performance on different types of stains and/or soils including bleachable stains like tea, grass, enzymatic stains like blood, greasy stains like barbecue sauce, spaghetti sauce, bacon grease and the like. The presence of said surfactants in the compositions herein may also allow to provide compositions with desired viscosity by appropriately chosen surfactants and levels thereof. Said surfactants help the stable incorporation of said polymer in the compositions of the present invention. Indeed, in the preferred embodiment wherein the compositions herein comprise a bleach, preferably a source of active oxygen, and/or has a low pH, the use of surfactants, may stabilise the polymers described herein. In particular, the silicone glycols as described herein may be stabilised in the above described harsh conditions by micelles formed by certain surfactants.

All types of surfactants may be used in the present invention including nonionic anionic, cationic, amphoteric or zwitterionic surfactants. It is also possible to use mixtures of such surfactants without departing from the spirit of the present invention.

Accordingly, the compositions according to the present invention comprise up to 50%, preferably of from 0.1% to 20%, more preferably of from 1% to 10%, and most preferably of from 1% to 5% by weight of the total composition of a surfactant, or mixtures there.

Suitable cationic surfactants to be used herein include derivatives of quaternary ammonium, phosphonium, imidazolium and sulfonium compounds. Preferred cationic surfactants for use herein are quaternary ammonium compounds wherein one or two of the hydrocarbon groups linked to nitrogen are a saturated, linear or branched alkyl group of 6 to 30 carbon atoms, preferably of 10 to 25 carbon atoms, and more preferably of 12 to 20 carbon atoms, and wherein the other hydrocarbon groups (i.e. three when one hydrocarbon group is a long chain hydrocarbon group as mentioned hereinbefore or two when two hydrocarbon groups are long chain hydrocarbon groups as mentioned hereinbefore) linked to the nitrogen are independently substituted or unsubstituted, linear or branched, alkyl chain of from 1 to 4 carbon atoms, preferably of from 1 to 3 carbon atoms, and more preferably are methyl groups.

In the preferred embodiment of the present invention where persulfate salts or mixtures thereof are used as sources of active oxygen, the quaternary ammonium compound is preferably a non-chloride/non halogen quaternary ammonium compound. The counterion used in said quaternary ammonium compounds are compatible with any source of active oxygen and are selected from the group of methyl sulfate, or methylsulfonate, and the like.

Particularly preferred to be used in the compositions of the present invention are trimethyl quaternary ammonium compounds like myristyl rimethylsulfate, cetyl trimethylsulfate and/or tallow trimethylsulfate. Such trimethyl quaternary ammonium compounds are commercially available from Hoechst, or from Albright & Wilson under the trade name EMPIGEN CM®.

Suitable amphoteric surfactants to be used in the compositions according to the present invention include amine oxides having the following formula R₁R₂R₃NO wherein each of R1, R2 and R3 is independently a saturated substituted or unsubstituted, linear or branched alkyl groups of from 1 to 30 carbon atoms, preferably of from 6 to 30 carbon atoms, more preferably of from 10 to 20 carbon atoms, and most preferably of from 8 to 18 carbon atoms. Suitable amine oxides for use herein are preferably compatible with source of active oxygen. Preferred amine oxides for use herein are for instance natural blend C8-C₁₀ amine oxides as well as C12-C16 amine oxides commercially available from Hoechst.

Suitable short chain amine oxides to be used according to the present invention are amine oxides having the following formula R₁R₂R₃NO wherein R1 is a C6 to C10 alkyl group, preferably a C8 to C10 alkyl group and wherein R2 and R3 are independently substituted or unsubstituted, linear or branched alkyl groups of from 1 to 4 carbon atoms, preferably of from 1 to 3 carbon atoms, and more preferably are methyl groups. R1 may be a saturated linear or branched alkyl group. Suitable short chain amine oxides for use herein are preferably compatible with any source of active oxygen. Preferred short chain amine oxides for use herein are for instance natural blend C8-C10 amine oxides available from Hoechst.

Suitable nonionic surfactants to be used herein are alkoxylated fatty alcohol nonionic surfactants that can be readily made by condensation processes that are well known in the art. Indeed, a great variety of such alkoxylated fatty alcohols are commercially available which have very different HLB values. The HLB values of such alkoxylated nonionic surfactants depend essentially on the chain length of the fatty alcohol, the nature of the alkoxylation and the degree of alkoxylation. Hydrophilic nonionic surfactants tend to have a high degree of alkoxylation and a short chain fatty alcohol, while hydrophobic surfactants tend to have a low degree of alkoxylation and a long chain fatty alcohol. Surfactants catalogues are available which list a number of surfactants including nonionics, together with their respective HLB values.

Accordingly, preferred alkoxylated alcohols for use herein are nonionic surfactants according to the formula RO(E)e(P)pH where R is a hydrocarbon chain of from 2 to 24 carbon atoms, E is ethylene oxide and P is propylene oxide, and e and p which represent the average degree of, respectively ethoxylation and propoxylation, are of from 0 to 24. The hydrophobic moiety of the nonionic compound can be a primary or secondary, straight or branched alcohol having from 8 to 24 carbon atoms. Preferred nonionic surfactants for use in the compositions according to the invention are the condensation products of ethylene oxide with alcohols having a straight alkyl chain, having from 6 to 22 carbon atoms, wherein the degree of ethoxylation is from 1 to 15, preferably from 5 to 12. Such suitable nonionic surfactants are commercially available from Shell, for instance, under the trade name Dobanol® or from Shell under the trade name Lutensol®. These nonionics are preferred because they have been found to allow the formulation of a stable product without requiring the addition of stabilisers or hydrotropes. When using other nonionics, it may be necessary to add hydrotropes such as cumene sulphonate or solvents such as butyldiglycolether.

Particularly suitable anionic surfactants are alkyl-diphenyl-ether-sulphonates and alkyl-carboxylates. Other, suitable anionic surfactants herein include water soluble salts or acids of the formula ROSO₃M wherein R is preferably a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Other anionic surfactants useful for detersive purposes can also be used herein. These can include salts (including, for example, sodium, potassium, ammonium, and substituted ammonium salts such as mono-, di- and triethanolamine salts) of soap, C₉-C₂₀ linear alkylbenzenesulfonates, C₈-C₂₂ primary or secondary alkanesulfonates, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄₋₁₆ methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO—M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Preferred anionic surfactants for use in the compositions herein are the alkyl benzene sulfonates, alkyl sulfates, alkyl alkoxylated sulfates, and mixtures thereof.

Thickening System

The compositions herein may comprise a thickener or a thickening system as a highly preferred optional ingredient.

Suitable thickeners herein are selected from the group consisting of organic thickeners and inorganic thickeners and mixtures thereof, preferably organic thickeners, more preferably polysaccharides, and most preferably xanthan gum.

Suitable thickening systems are selected from the group consisting of a cationic/anionic surfactant system self-thickening systems.

Preferably, the compositions herein comprise xanthan gums as a thickener.

The compositions according to the present invention may comprise from 0.05% to 10%, preferably from 0.05% to 5%, more preferably from 0.05% to 3% by weight of the total composition of a thickener or a thickening system.

Depending on the end use envisioned, the compositions according to the present invention may further comprise a variety of other ingredients including dyes, solvents, optical brighteners, builders, chelants, pigments, solvents, buffering agents, radical scavengers, polymers, stabilizers and the like.

### EXAMPLES

The following examples will further illustrate the present invention. The compositions are made by combining the listed ingredients in the listed proportions (weight % unless otherwise specified) Furthermore, the compositions comprise water and minors up to 100%.

The following Examples (compositions I to VI) are meant to exemplify compositions according to the present invention but are not necessarily used to limit or otherwise define the scope of the present invention. Furthermore, the following Examples (VII to IX) include comparative examples.

| Ingredients | Weight % |
|---|---|
| Kelzan T ® (Xanthan Gum) | 0.3 |
| HLAS (linear alkylbenzene sulfonic acid) | 2.0 |
| Sulfuric acid | 1.0 |
| Silicone SF1288 ® | 5.0 |
| Hydrogen peroxide | 1.0 |

| II) | |
|---|---|
| Ingredients | Weight % |
| Kelzan T (Xanthan Gum) | 0.6 |
| Dobanol 91.8 ® | 2.0 |
| Hydrochloric acid | 9.0 |
| L-7608 ® (Dow Corning) | 2.0 |

| III) | |
|---|---|
| Ingredients | Weight % |
| Sulfuric acid | 3.0 |
| Hexadecyl dimethyl amineoxide | 1.0 |
| Decyl dimethyl amineoxide | 3.0 |
| Silicone DC 193 ® | 2.0 |
| Curox ® (potassium monopersulfate) | 4.0 |

| IV) | |
|---|---|
| Ingredients | Weight % |
| Kelzan T ® (Xanthan Gum) | 1 |
| HLAS (linear alkylbenzene sulfonic acid) | 2.0 |
| Sulfamic acid | 2.0 |
| Silicone DC 5220 ® | 5.0 |

| V) | |
|---|---|
| Ingredients | Weight % |
| Hydroxyethylcellulose | 1 |
| Silicone SF1188 ® | 7.0 |
| Hydrogen peroxide | 0.5 |

| VI) | |
|---|---|
| Ingredients | Weight % |
| Citric acid | 5 |
| Silicone SF1288 ® | 7.0 |
| Kelzan T ® (Xanthan Gum) | 0.5 |
| Sodium alkyl sulfate | 4 |
| N-Butoxy propoxy propanol | 4.0 |

| VII) | |
|---|---|
| Ingredients | Weight % |
| Kelzan T ® (Xanthan Gum) | 0.5 |
| Dobanol 91.8 ® | 1.0 |
| Maleic acid | 2.0 |
| PVP | 0.2 |

| VIII) | |
|---|---|
| Ingredients | Weight % |
| Kelzan T ® (Xanthan Gum) | 0.3 |
| HLAS (linear alkylbenzene sulfonic acid) | 1.0 |
| PVNO | 0.5 |
| Hydrogen peroxide | 3.0 |

| IX) | |
|---|---|
| Ingredients | Weight % |
| Trimethl hexadecl ammonium methane sulfate | 3.0 |
| Decyl dimethyl amineoxide | 0.5 |
| Silicone SM 2059 ® (curable amino silicone) | 2.0 |
| Curox ® | 2.0 |

What is claimed is:

1. A solid or thickened compositions, suitable for cleaning a surface, said composition comprising a polymer, wherein said composition increases the hydrophobicity of said surface such that the contact angle between water and said surface is comprised between 30° and 55° for at least 5 rinse-dry cycles of said surface.

2. The composition according to claim 1, wherein said composition further comprises a bleaching agent wherein said bleaching agent is selected from the group consisting of sources of active oxygen, hypohalite bleaches, and any mixtures thereof.

3. The composition according to claim 2, wherein said composition comprises from 0.1% to 30% by weight of said bleaching agent.

4. The composition according to claim 1, wherein said contact angle between water and said surface is comprised between 30° to 50°.

5. The composition according to claim 1, wherein said contact angle between water and said surface remains for at least 15 rinse-dry cycles of said surface.

6. The composition according to claim 1, wherein said polymer is a soil adhesion prevention polymer.

7. The composition according to claim 1, wherein said polymer is a linear or grafted silicone glycol polymer.

8. The composition according to claim 7, wherein said polymer is a linear or grafted silicone glycol polymer according to the following formula:
R₁ R₁ R₁ R₁ 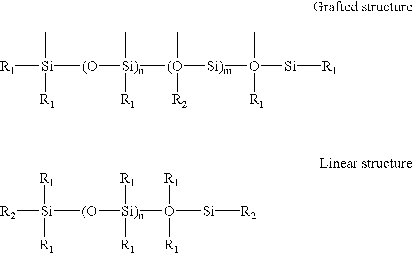
wherein each R₁ independently is H or a hydrocarbon radical; R₂ is a group bearing a polyether functional group; n is an integer comprised between 0 and 500; and wherein m is an integer comprised between 1 and 300.

9. The composition according to claim 8 wherein n+m is greater than 1

10. The composition according to claim 7, wherein said composition comprises up to 50% by weight of said silicone glycol.

11. The composition according to claim 8, wherein said composition comprises up to 50% by weight of said silicone glycol.

12. The composition according to claim 1, wherein said composition is a thickened composition having a viscosity of at least 2 cps at 20° C. when measured with a CSL² 100® Rheometer at 20° C. with a 4 cm spindle.

13. The composition according to claim 12 wherein said composition has a viscosity of 2 to 5000 cps when measured with a CSL² 100® Rheometer at 20° C. with a 4 cm spindle.

14. The composition according to claim 13 wherein said composition has a viscosity of 2 to 500 cps when measured with a CSL² 100® Rheometer at 20° C. with a 4 cm spindle.

15. The composition according to claim 12, wherein said composition further comprises a thickening agent.

16. The composition according to claim 12, wherein said composition is acidic.

17. A method of cleaning a surface with a solid or thickened composition said method comprising the steps of:
contacting said surface with a composition comprising a polymer, wherein said composition increases the hydrophobicity of said surface, such that a contact angle between water and said surface is comprised between 30° and 55° for at least 5 rinse-dry cycles of said surface.

18. The method of claim 17 wherein said composition provides a soil adherence prevention benefit.

19. The method of claim 17 wherein said composition provides a limescale and/or mineral encrustation build-up prevention benefit.

20. The method of claim 17 wherein said composition provides a feces anti-stick and/or bacteria adhesion reduction benefit.
